(19) United States
(12) Patent Application Publication
(10) Pub. No.: US 2025/0228295 A1
(43) Pub. Date: Jul. 17, 2025

(54) A Wicking Element for a Heating System for an Aerosol Generating Set, and Associated Heating System and Manufacturing Method

(71) Applicant: JT International SA, Geneva (CH)

(72) Inventor: Jaakko McEvoy, Vienna (AT)

(73) Assignee: JT International SA, Geneva (CH)

(21) Appl. No.: 18/702,854

(22) PCT Filed: Dec. 1, 2022
(86) PCT No.: PCT/EP2022/084067

§ 371 Date: Apr. 19, 2024

(30) Foreign Application Priority Data
Dec. 1, 2021 (EP) 21211678.4

(51) Int. Cl. A24F 40/44; A24F 40/10; A24F 40/70; B33Y 10/00; B33Y 80/00

(52) U.S. Cl. CPC A24F 40/44; A24F 40/10; A24F 40/70; B33Y 10/00; B33Y 80/00

(57) ABSTRACT

A wicking element for a heating system for an aerosol generating set is manufactured in one single piece by an additive manufacturing technique by forming a plurality of successive porous layers; the plurality of successive porous layers including a first porous layer and a second porous layer adjacent to the first porous layer; each of the first and the second porous layers defining a hole pattern including a plurality of holes; the hole pattern of the second porous layer being at least partially offset in respect with the hole pattern of the first porous layer so that pairs of facing holes of these porous layers form a flow channel having a transversal area smaller than or equal to the transversal area of each of these holes.

### FIELD OF THE INVENTION

The present invention concerns a wicking element for a heating system for an aerosol generating set. The present invention also concerns a heating system and a manufacturing method associated to such a wicking element.

### BACKGROUND OF THE INVENTION

Different types of aerosol generating devices are already known in the art. Generally, such devices comprise a storage compartment for storing a liquid aerosol forming precursor. A heating system is formed of one or more electrically activated resistive heating elements arranged to heat said precursor to generate the aerosol. A wicking element in fluid communication with the storage compartment enables to provide the liquid aerosol forming precursor to the heating system. The aerosol is released into a flow path extending between an inlet and outlet of the device. The outlet may be arranged as a mouthpiece, through which a user inhales for delivery of the aerosol.

The wicking element can be made for example from ceramic or fibers (e.g., a bundle or fabric). These materials have generally intrinsic porosity enabling wicking effect. However, this intrinsic porosity cannot be easily controlled so as the wicking effect can be different from one wicking element to another. For example, the wicking effect can be too weak which leads to poor aerosol generating effect. The wicking effect can also be too strong which leads generally to leakages. In both cases, the user experience is deteriorated.

In order to better control the wicking effect, it is possible to manufacture flow channels inside the wicking elements made from substantially non-porous materials. The manufacturing can be carried out using well-known molding processes. However, such manufacturing method does not always allow creating flow channels of reduced dimensions inside the wicking elements. For example, it may be difficult to create a channel having transversal dimensions less than 100 μm, advantageously less than 50 μm and preferably less than 25 μm. Moreover, it may be difficult to create a complex network of flow channels allowing improved transfer of liquid. Thus, the wicking effect of such wicking elements cannot be entirely controlled that also leads to a poor user experience.

### SUMMARY OF THE INVENTION

One of the aims of the present invention is to provide a wicking element for a heating system for an aerosol generating set, creating wicking effect which can be easily controlled and predicted. Thus, the aerosol generating set using such a wicking element can ensure a better user experience.

For this purpose, the invention concerns a wicking element for a heating system for an aerosol generating set, the wicking element being manufactured in one single piece by an additive manufacturing technique by forming a plurality of successive porous layers;
the plurality of successive porous layers comprising a first porous layer and a second porous layer adjacent to the first porous layer;
each of the first and the second porous layers defining a hole pattern comprising a plurality of holes;
the hole pattern of the second porous layer being at least partially offset in respect with the hole pattern of the first porous layer so as pairs of facing holes of these porous layers form a flow channel having a transversal area smaller than or equal to the transversal area of each of these holes.

Using these features, it is possible to achieve any transversal dimension of each flow channel inside the wicking element. Particularly, it is clear that the transversal dimensions of these flow channels are formed by overlapped sections of facing holes of adjacent porous layers. The area of the overlapped sections and so the flow surface area between two adjacent layers, can be controlled at each level of adjacent layers by controlling an offset value between the hole patterns of these layers.

Depending on the additive manufacturing technique used to form the successive layers, minimal transversal dimensions of each hole are usually imposed by conventional manufacturing methods. According to the invention, in order to obtain smaller dimensions, it is possible to offset the hole patterns of adjacent layers. For example, for 3D printing manufacturing technique, a minimum hole size is defined by the illumination matrix (pixels on a screen), and is usually limited to around 10 μm and 110 μm. These transversal dimensions can be divided for example by 2 if the hole pattern of the next layer, which for example is identical to the hole pattern of the previous layer, is offset in each transversal direction by 50% of the corresponding transversal dimension. Thus, it is possible to obtain channels of any desired cross-sectional shape and dimensions by choosing in an appropriate way the offset between the hole patterns of adjacent layers.

Each hole pattern can be defined by holes forming a matrix extending along X and Y directions which can for example be perpendicular. The holes can be spaced by a same value according to each of these directions. The holes can for example have substantially a same shape and have for example substantially same dimensions according to each direction X and Y. The shape of the holes can be triangular, rectangular (for example square), circular or elliptical. In variant, the shape of the holes can present any other polygon.

Alternatively, holes can be spaced by different values in X and/or Y direction. The holes may be formed of variable shapes. A variable dimensional or shape pattern for the holes may be useful when considering wicking element of non-constant width such that the flow path can be controlled across different widths of the wicking element.

In some embodiments, the hole patterns of at least some adjacent layers can be only partially offset. This means that certain holes of these layers may face each other without offset and certain other holes of these layers may face each other with an offset.

According to some embodiments, the first porous layer and the second porous layer define substantially the same hole pattern.

Using these features, each porous layer can be formed in a same way. It is thus possible to achieve smaller transversal dimensions of each flow channel when the hole patterns of two adjacent layers are offset.

According to some embodiments, the holes of the or each hole pattern have a rectangular shape.

The hole having a rectangular shape can be easily created using for example a 3D printing technique.

According to some embodiments, the transversal dimensions of the holes of the or each hole pattern are comprised between 10 μm and 150 μm.

Using these features, it is possible to obtain flow channels inside the wicking element having cross-sectional dimensions smaller than 150 μm, advantageously smaller than 50 μm and preferably smaller than 10 μm.

According to some embodiments, the thickness of each porous layer is comprised between 25 μm and 100 μm.

Using these features, it is possible to achieve a relatively small thickness of each porous layer. Thus, relatively smooth external and internal shapes can be obtained. For example, inside each flow channel, it is possible to achieve a relatively smooth transition between adjacent layers despite the offset of the corresponding hole patterns. Thus, it is possible to avoid turbulent flows inside the channels.

According to some embodiments, the hole pattern of the second porous layer is offset according to at least one direction by an offset value, the offset value being less than the transversal dimension of at least one hole of the first porous layer according to this direction.

Using these features, it is possible to choose an offset value for the or each direction. The offset value can be expressed in % of the corresponding transversal direction. For example, in case of rectangular holes having identical dimensions, the adjacent layers can be in 50% offset according to each direction forming the rectangular shape of the holes. In this case, the transversal area of the flow channels is decreased by 4 in comparison with the transversal area of the holes.

According to some embodiments, the plurality of successive porous layers comprises N>2 successive porous layers;
each of the porous layers defining a hole pattern comprising a plurality of holes;
the hole pattern of each porous layer being at least partially offset in respect with the hole pattern of the or each porous layer adjacent to said porous layer so as facing holes of these porous layers form a flow channel having a transversal area less or equal than the transversal area of each of these holes.

Using these features, it is possible to create flow channels extending through several layers of the wicking element. For example, the flow channels can extend through the whole wicking element. Additionally, by choosing offset values between the hole patterns of each layer in an appropriate way, it is possible to vary cross-sectional shape of each channel along its length. Thus, for example, in an inlet portion, the channels can have greater cross-sectional dimensions than in an outlet portion. Moreover, the channels can extend through the wicking element parallel between them or according to any other suitable path. The paths of different channels can cross each other. In some cases, throughout the wicking element, a channel can be separated in two or more channels. In some cases, two or more channels can form a unique channel.

In a general case, the disposition, path and/or cross-sectional shape of the channels can be optimized using an optimization tool, for example using a Computational Fluid Dynamics (CFD) optimization tool. These elements can thus be determined numerically and when, reproduced identically by an additive manufacturing technique, like 3D printing.

According to some embodiments, the wicking element is made of ceramic, preferably with substantially 0% intrinsic porosity.

Since the material forming the wicking element has no intrinsic porosity, its wicking effect can be determined very precisely based on the flow channel geometry, for example analytically or using a numeral tool.

According to some embodiments, said additive manufacturing technique is a Lithography-based Ceramic Manufacturing technique.

The Lithography-based Ceramic Manufacturing (LCM) technique allows for complex ceramic structures to be produced through additive manufacturing (like 3D printing for example). For carrying out this technique, the ceramic may be in a particle form, usually with a monodisperse distribution and is mixed with UV curable polymer resin in a slurry. As each layer of the print is exposed to the UV light, the polymer component is cured and holds the ceramic particles in position. The next layer is exposed above the last layer, therefore building a joined part. Once the part is removed from the printer, it is still fragile and very flexible as it is only a polymer with ceramic imbedded in it at this point. This part is referred to as being in the “green state”. This part is then placed into a furnace and fired to high temperatures >1600 C.°, which burns out the polymer component and sinters the ceramic particles together to leave a purely ceramic component. If the part is fired to lower temperatures e.g. 1200 C.°, then the polymer still burns out completely but the final ceramic can have porous gaps in it.

According to some embodiments, the wicking element forms a wicking part adapted to transfer an e-liquid and at least one element chosen in the group:
a heat transfer element;
a flow passage;
a support structure;
an insulation structure.

Using these features, the wicking element can form with at least one the cited additional elements a single piece. Such a piece is manufactured in a simple way using the corresponding additive manufacturing technique. Thus, the production costs and complexity can be reduced. Additionally, the wicking element combined with at least one of the pre-cited elements can be more easily assembled with the rest of the heating system.

The present invention also concerns a heating system for an aerosol generating set, comprising the wicking element as defined above.

The present invention also concerns a manufacturing method of the wicking element as defined above, the method comprising:
forming a first porous layer comprising a plurality of holes according to a hole pattern;
forming a second porous layer comprising a plurality of holes according to a hole pattern at least partially offset in respect with the hole pattern of the first porous layer so as pairs of facing holes of these porous layers form a flow channel having a transversal area less or equal than the transversal area of each of these holes.

According to some embodiments, the manufacturing method comprises a step of forming a non-porous layer.

According to some embodiments, the manufacturing method, wherein said non-porous layer is designed to form at least one element chosen in the group:
a heat transfer element;
a flow passage;
a support structure;
an insulation structure.

Thanks to these features, it is possible to form the wicking element in one single piece with at least one of said additional elements. Thus, the production costs and complexity can be reduced. Additionally, the wicking element combined with at least one of the pre-cited elements can be more easily assembled with the rest of the heating system.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a schematic view of an aerosol generating set according to the invention, the aerosol generating set comprising a wicking element according to the invention;

FIG. 2 is a schematic view of the wicking element of FIG. 1;

FIG. 3 is a cross-sectional perspective view of the wicking element of FIG. 1, according to an example different from the example of FIG. 2;

FIG. 4 is a schematic view of a hole pattern used to form at least one layer of the wicking element of FIG. 1;

FIG. 5 is a schematic view of two overlapped hole patterns used to form at least a pair of adjacent layers of the wicking element of FIG. 1; and

FIG. 6 is a perspective view of the wicking element of FIG. 1 with visible flow channels.

### DETAILED DESCRIPTION OF THE INVENTION

Before describing the invention, it is to be understood that it is not limited to the details of construction set forth in the following description. It will be apparent to those skilled in the art having the benefit of the present disclosure that the invention is capable of other embodiments and of being practiced or being carried out in various ways.

As used herein, the term “aerosol generating device” or “device” may include a vaping device to deliver an aerosol to a user, including an aerosol for vaping, by means of aerosol generating unit (e.g., an aerosol generating element which generates vapor which condenses into an aerosol before delivery to an outlet of the device at, for example, a mouthpiece, for inhalation by a user). The device may be portable. “Portable” may refer to the device being for use when held by a user. The device may be adapted to generate a variable amount of aerosol, e.g. by activating a heater system for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapor to be provided (so as to mimic the effect of smoking a conventional combustible smoking article such as a cigarette, cigar or pipe, etc.). The device may include a temperature regulation control to drive the temperature of the heater and/or the heated aerosol generating substance (aerosol pre-cursor) to a specified target temperature and thereafter to maintain the temperature at the target temperature that enables efficient generation of aerosol.

As used herein, the term “aerosol” may include a suspension of precursor as one or more of: solid particles; liquid droplets; gas. Said suspension may be in a gas including air. Aerosol herein may generally refer to/include a vapor. Aerosol may include one or more components of the precursor.

As used herein, the term “liquid aerosol forming material” or “aerosol forming precursor” or “precursor” or “aerosol forming substance” or “substance” or “vaporizable material” is used to designate any material that is vaporizable in air to form aerosol. Vaporisation is generally obtained by a temperature increase up to the boiling point of the vaporization material, such as at a temperature up to 310° C., preferably up to 300° C. and in some cases up to 265° C. The vaporizable material may, for example, comprise or consist of an aerosol-generating liquid or gel. The vaporizable material may comprise one or more of: nicotine; caffeine or other active components. The active component may be carried with a carrier, which may be a liquid. The carrier may include propylene glycol or glycerin. A flavoring may also be present. The flavoring may include Ethylvanillin (vanilla), menthol, Isoamyl acetate (banana oil) or similar.

### DESCRIPTION OF THE INVENTION

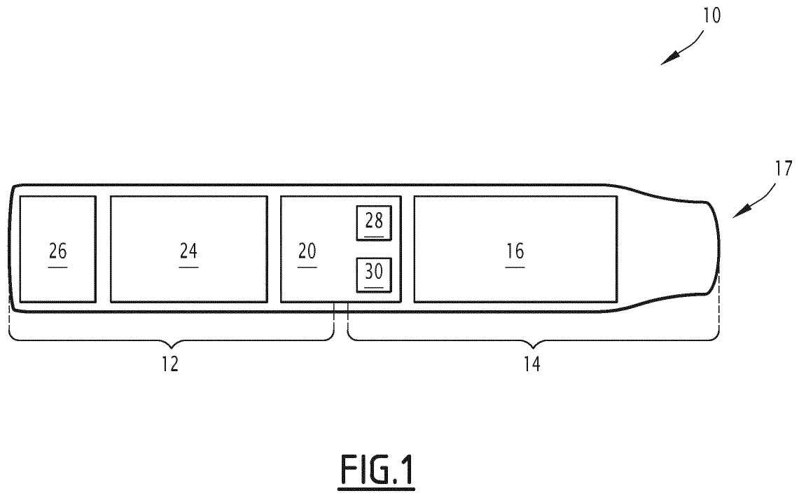

FIG. 1 shows an aerosol generating set 10 according to the invention. In the example of this Figure, the aerosol generating set 10 comprises an aerosol generating device 12 and a cartridge 14.

The aerosol generating device 12 is configured to operate with the cartridge 14. In particular, the aerosol generating device 12 comprises a device body defining a cavity configured to receive the cartridge 14. The cartridge 14 and the aerosol generating device 12 may be detachably engaged in a functioning relationship. Various mechanisms may be used to connect the cartridge 14 and the aerosol generating device 12 that include a threaded engagement, a press-fit engagement, an interference fit, a magnetic engagement, or the like. In a variant, the cartridge 14 may be fixed permanently to the device 12. The aerosol delivery set 10 may be substantially rod-like shaped, as shown on FIG. 1.

In reference to FIG. 1, the aerosol generating set 10 comprises a storage compartment 16 which is arranged, in the example of this Figure, in the cartridge 14. The storage compartment 16 comprises a liquid aerosol forming material. In a variant (not-shown), the storage comportment 16 is integrated in the device 12 and can be refilled by the user. In this case, no cartridge is necessary to operate with the device 12.

The cartridge 14 may comprise a mouthpiece 17 arranged at the downstream end of the cartridge 14. “Downstream” and “upstream” are defined with reference to an airflow flowing out of the cartridge 14. The mouthpiece 17 defines at least one airflow channel comprising at least one air outlet. The mouthpiece 17 may be attached on the distal end of the cartridge 14 or may be a part of the cartridge 14. In use, a user may draw the air from the mouthpiece to cause the air to flow into the aerosol generating set 10 from an air inlet of the aerosol generating device 12 through the cartridge 14.

In reference to FIG. 1, the aerosol generating set 10 further comprises a heating system 20, a power supply 24 and a controller 26. The power supply 24, comprising for example a battery, is adapted to power the heating system 20. The controller 26 is adapted to control the powering of the heating system 20 by the power supply 24. Particularly, the controller 26 is adapted for example to control an ON/OFF state of the heating system 20 based on user's commands.

In the example of FIG. 1, the heating system 20 comprises a device part integrated in the device 12 and a cartridge part integrated in the cartridge 14. The device part comprises for example a pair of device contacts connected electrically to the power supply 24 via the controller 26. The cartridge part comprises a pair of cartridge contacts designed to be engaged with the pair of device contacts when the cartridge 14 is engaged with the device 12, a heater 28 designed to evaporate the liquid aerosol forming material from the storage compartment 16 and a wicking element 30 at least partially delimiting the storage compartment 16 or partially inserted in and protruding from the storage compartment and designed to conduct the aerosol forming material as it will be explained in further detail below. According to other embodiments of the invention, any other arrangement of the elements of the heating system 20 in respect with the device 12 and cartridge 14 is possible. For example, the heater 28 and in some cases, the wicking element 30 can be arranged in the device part of the heating system 20.

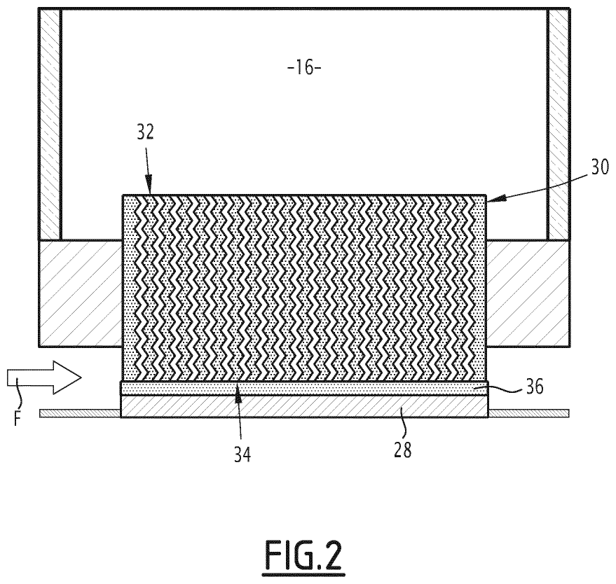

As it is shown in FIG. 2, the wicking element 30 comprises an absorbing surface 32 which is in contact with the liquid aerosol forming material of the storage portion 16 and a releasing surface 34 which faces or is in direct or indirect contact with the heater 28. The wicking element 30 is thus configured to conduct the aerosol forming material in liquid or evaporated form from the absorbing surface 32 to the releasing surface 34 via flow channels formed inside this wicking element 30.

The heater 28 is formed of one or more electrically activated resistive heating elements arranged to heat the liquid aerosol forming material to generate the aerosol. In a variant, the heater 28 may be an induction heater. In another variant, the heater 28 may be a nebulizer, in particular a vibrating mesh nebulizer, a thermal inkjet printhead or a surface acoustic wave nebulizer. In a variant, the heater 28 is an ohmic heater.

An example of a respective arrangement of the heater 28, the wicking element 30 and the storage portion 16 is shown in FIG. 2. According to this example, the heater 28 is in indirect contact with the releasing surface 34 of the wicking element 30. Particularly, according to this example, a porous membrane 36 is provided between the heater 28 and the releasing surface 34. The porous membrane 36 forms thus a mechanical interface between the wicking element 30 and the heater 28. The heater 28 is thus able to heat the liquid aerosol forming material present in the porous membrane 30. In operation, the evaporated liquid is mixed with an airflow, represented by the arrow F in FIG. 2, coming from an air inlet arranged in the device 12 and flowing through the membrane 36 in direction of the mouthpiece 17 to provide the generated aerosol to the user. In the example of FIG. 2, the wicking element 30 is made in one single piece, as it will be explained in further detail below.

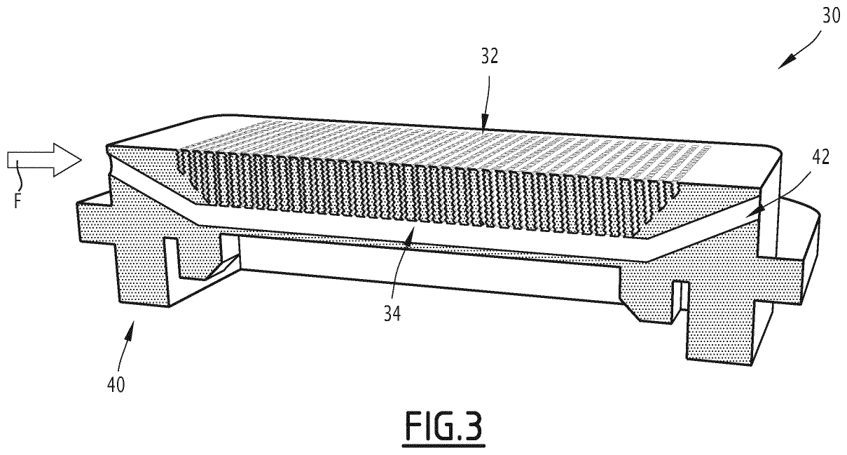

FIG. 3 shows an example of the wicking element 30 where it includes an additional element forming a heat transfer element 40. According to this example, the heat transfer element 40 is in contact with the heater 28 and designed to be heated directly by the heater 28. A flow passage 42 is formed between the releasing surface 34 of the wicking element 32 and the heat transfer element 40. The flow passage 42 is designed to mix the evaporated liquid with the airflow, represented by the arrow F in FIG. 3, coming from an air inlet arranged in the device 12 and flowing in direction of the mouthpiece 17 to provide the generated aerosol to the user. In the example of FIG. 3, the wicking element 30 and the heat transfer element 40 are made in one single piece, as it will be explained in further detail below. This piece forms additionally the flow passage 42.

According to other examples of the invention, the wicking element 30 may be made in one single piece with any other element of the heating system 20 and/or of the cartridge 14 and/or of the device 12. For example, the wicking element 30 can be made in one single piece with a support structure or with an insulation structure of the heating system 20 and/or of the cartridge 14 and/or of the device 12.

The wicking element 30 is made in one single piece using an additive manufacturing technique, like for example 3D printing. According to a particular example of the invention, the wicking element 30 is made of ceramic. In this case, the additive manufacturing technique used to make the wicking element 30 is for example a Lithography-based Ceramic Manufacturing (LCM) technique. Advantageously, according to the invention, the ceramic used to make the wicking element 30 or any other material used to make the wicking element 30 presents substantially 0% intrinsic porosity. In the preferred embodiment of the invention, the wicking element 30 comprises or is formed of alumina. In other embodiments, the wicking element 30 comprises or is formed of zirconia, silicon nitride, cermets, porcelain, bioglass, titanium dioxide, magnesia, cordierite, piezoceramics, or mixes of materials such as alumina reinforced zirconia. Any custom ceramic powder can be used for the wicking element 30.

The wicking element 30 and according to some embodiments at least one additional element as mentioned above, is (are) made by forming a plurality of successive porous layers and non-porous layers. The number of these layers depends on the thickness of the wicking element 30. The thickness of each layer is for example comprised between 25 μm and 100 μm. The porous layers are intended to form a plurality of flow channels inside the wicking element 30. For this purpose, each porous layer delimits a plurality of through holes, according to a hole pattern. A same hole pattern can be used to form at least some porous layers, for example substantially all porous layers of the wicking element 30. The non-porous layers are for example intended to form at least one additional element.

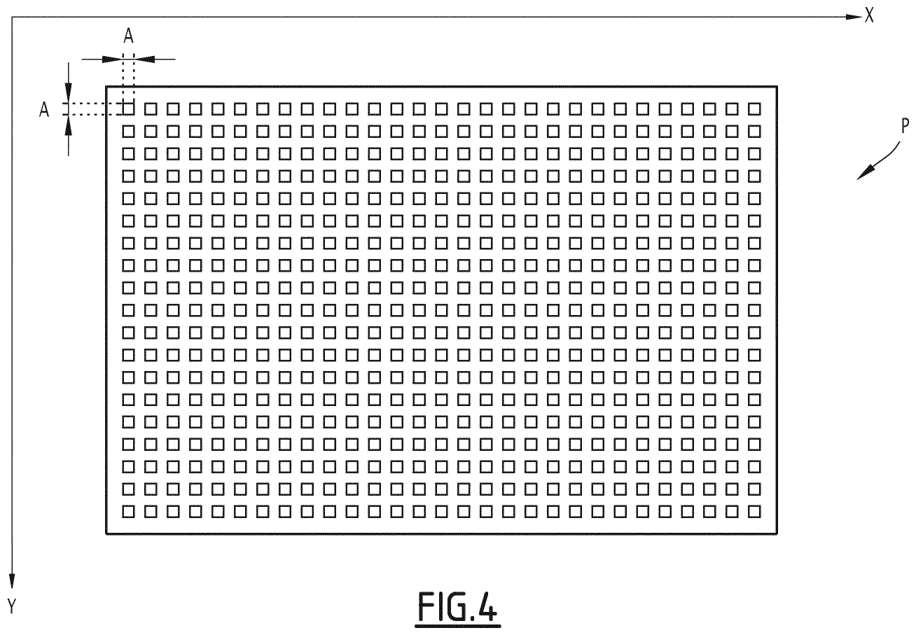

An example of a hole pattern P is shown in FIG. 4. According to this example, the hole pattern P is defined by holes forming a matrix extending along X and Y directions which can for example be perpendicular. The holes can be spaced by a same value according to each of these directions X, Y. The holes can for example have substantially a same shape and have for example substantially same dimensions according to each direction X and Y. In the example of FIG. 4, the holes have a square shape with for example sides of identical length A. This length A is for example comprised between 10 μm and 150 μm.

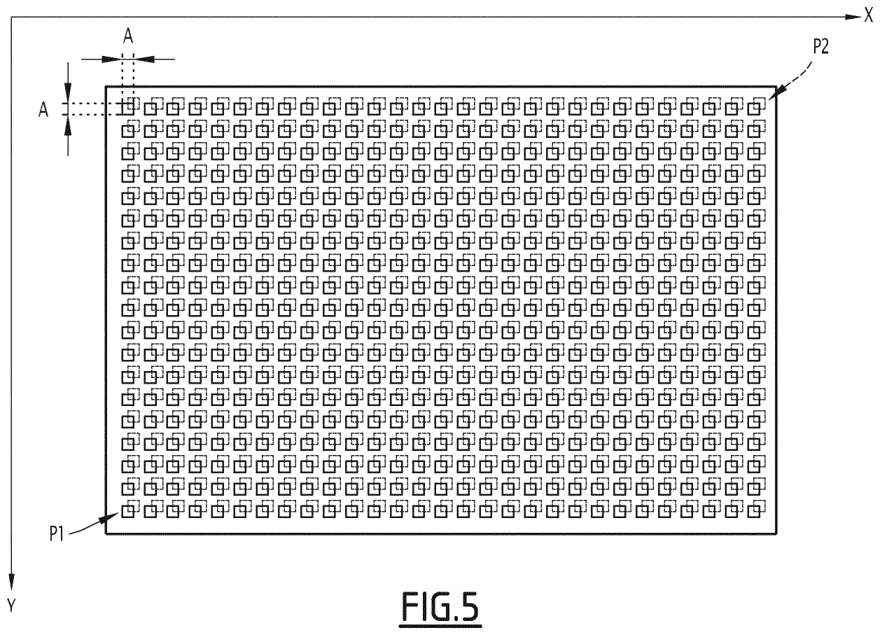

According to the invention, the hole patterns of at least some adjacent layers are at least partially in offset so as pairs of facing holes of these porous layers form a flow channel having a transversal area less or equal than the transversal area of each of these holes. FIG. 5 shows an example of two adjacent layers having overlapped hole patterns P1 and P2. Particularly, in the example of this FIG. 5, the hole pattern P2 is in offset with the hole pattern P1 according to each direction X and Y by a same offset value. The offset value can for example be expressed in % of the hole dimension according to the corresponding direction. In the example of FIG. 5, the offset value is equal to 50% of length A. Thus, the area of the overlapped portion of facing holes is equal to ¼ A².

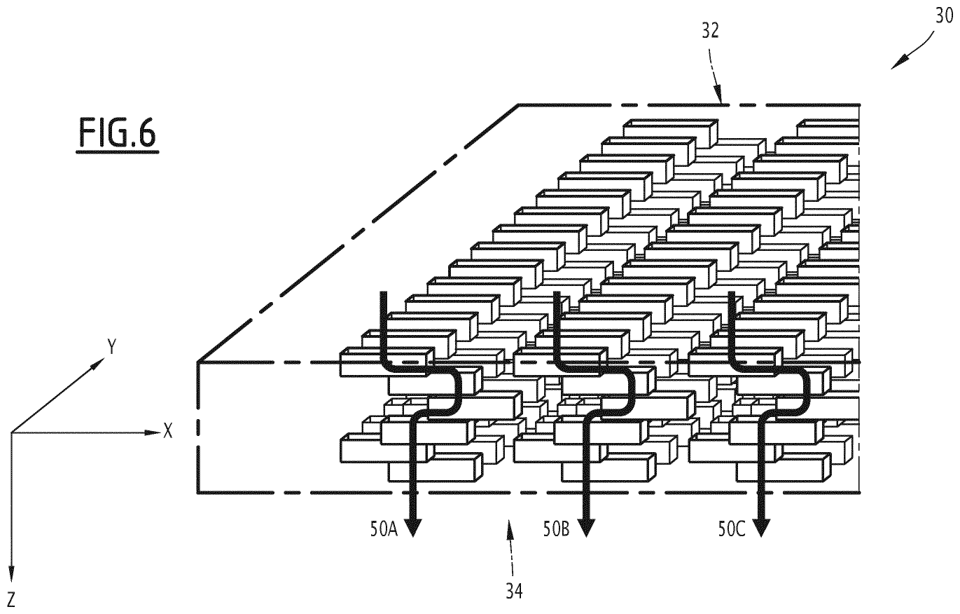

FIG. 6 shows the wicking element 30 formed by five layers arranged successively according to Z direction. Each layer comprises a plurality of through holes which are arranged according to a same hole pattern. The hole patterns of adjacent layers are offset according to X direction by an offset value equal for example to 50% of the hole dimension according to this direction. Facing holes of these adjacent layers form flow channels 50A, 50B, 50C extending from the absorbing surface 32 to the releasing surface 34. The cross-section area of each flow channel 50A, 50B, 50C is thus divided by 2 in comparison with the case of aligned hole patterns.

A manufacturing method of the wicking element 30 according to the invention will now be explained. As mentioned above, this method is carried out using an additive manufacturing technique, like for example 3D printing. The manufacturing method comprises thus forming successive layers so as the hole patterns of at least some adjacent layers are offset. For example, the method may comprise a step of forming a first porous layer comprising a plurality of holes according to a hole pattern and a step of forming a second porous layer comprising a plurality of holes according to a hole pattern at least partially offset in respect with the hole pattern of the first porous layer. The second porous layer is formed on the first porous layer. These steps can then be repeated depending on the thickness of the wicking element 30. It should also be noted that depending on the shape of the wicking element 30, the manufacturing method can further comprise one or several steps of forming a non-porous layer. Such a non-porous layer does not define holes and thus, does not form flow channels as defined above. The non-porous layers can for example correspond to any additional element forming one single piece with the wicking element 30, as for example the heat transfer element 40.

1. A wicking element for a heating system for an aerosol generating set, the wicking element being manufactured in one single piece by an additive manufacturing technique by forming a plurality of successive porous layers;
the plurality of successive porous layers comprising a first porous layer and a second porous layer adjacent to the first porous layer;
each of the first and second porous layers defining a hole pattern comprising a plurality of holes;
the hole pattern of the second porous layer being at least partially offset in respect with the hole pattern of the first porous layer so that pairs of facing holes of the first and second porous layers form a flow channel having a transversal area smaller than or equal to a transversal area of each of the holes.

2. The wicking element according to claim 1, wherein the first porous layer and the second porous layer define substantially the same hole pattern.

3. The wicking element according to claim 1, wherein the plurality of holes of the hole pattern of the first porous layer and/or the second porous layer have a rectangular shape.

4. The wicking element according to claim 1, wherein transversal dimensions of the holes of the hole pattern of the first porous layer and/or the second porous layer are between 10 μm and 150 μm.

5. The wicking element according to claim 1, wherein a thickness of each porous layer is comprised between 25 μm and 100 μm.

6. The wicking element according to claim 1, wherein the hole pattern of the second porous layer is offset according to at least one direction by an offset value, the offset value being less than a transversal dimension of at least one hole of the first porous layer according to the at least one direction.

7. The wicking element according to claim 1, wherein the plurality of successive porous layers comprises N>2 successive porous layers;
each of the porous layers defining a hole pattern comprising a plurality of holes;
the hole pattern of each porous layer being at least partially offset in respect with the hole pattern of each porous layer adjacent to said porous layer so that facing holes of the porous layers form a flow channel having a transversal area less or equal than a transversal area of each of the holes.

8. The wicking element according to claim 1, wherein the plurality of successive porous layers are made of ceramic.

9. The wicking element according to claim 1, forming a wicking part adapted to transfer an e-liquid, and at least one of:
a heat transfer element;
a flow passage;
a support structure; or
an insulation structure.

10. A heating system for an aerosol generating set, comprising the wicking element according to claim 1.

11. A manufacturing method of a wicking element, comprising:
forming a first porous layer comprising a plurality of holes according to a hole pattern; and
forming a second porous layer comprising a plurality of holes according to a hole pattern at least partially offset in respect with the hole pattern of the first porous layer so that pairs of facing holes of the porous layers form a flow channel having a transversal area less or equal than a transversal area of each of the holes.

12. The manufacturing method according to claim 11, further comprising a step of forming a non-porous layer.

13. The manufacturing method according to claim 12, wherein said non-porous layer is configured to form at least one of:
a heat transfer element;
a flow passage;
a support structure; or
an insulation structure.

14. The manufacturing method according to claim 11, wherein an additive manufacturing technique used to manufacture the wicking element is a Lithography-based Ceramic Manufacturing technique.

15. The wicking element according to claim 8, wherein the ceramic has substantially 0% intrinsic porosity.
